(19) United States
(12) Patent Application Publication
(10) Pub. No.: US 2025/0294291 A1
(43) Pub. Date: Sep. 18, 2025

(54) METHOD AND SYSTEM FOR AUDIO OUTPUT MATCHING

(71) Applicant: ROCKBOT, INC., Oakland, CA (US)

(72) Inventors: Itai Ben-Gal, West Bloomfield, MI (US); Victor Nemirovsky, Birmingham, MI (US)

(21) Appl. No.: 19/077,636

(22) Filed: Mar. 12, 2025

Related U.S. Application Data
(60) Provisional application No. 63/564,169, filed on Mar. 12, 2024.

(51) Int. Cl. H04R 3/12; H04R 29/00

(52) U.S. Cl. CPC H04R 3/12; H04R 29/002; H04R 2430/01

(57) ABSTRACT

A method for automatically matching output volume of a plurality of audio components, the method comprising: a) establishing reference volume profile at a set of one or more predetermined conditions; b) establishing a first volume profile for a first audio component; c) establishing a second volume profile(s) for a second audio component(s); d) performing a first mapping step of the first volume profile relative to the reference volume profile; e) performing a second mapping step(s) of the second volume profile(s) relative to the reference volume profile; f) calculating a normalization profile; and g) automatically adjusting a volume of the first and/or second audio component to a desired volume.

### CROSS REFERENCE TO RELATED APPLICATIONS

This application claims the benefit of U.S. Provisional Patent Application No. 63/564,169 filed on Mar. 12, 2024, which is incorporated herein by reference in its entirety.

### FIELD

The present teachings relate to a method and system which may provide a user a means of interacting with a plurality of audio components at same or similar volumes or sound intensities. The present teachings may find particular use in allowing a user to compare the audio quality of different audio components configured with different volume profiles by automatically matching the volumes of the audio components to one another.

### BACKGROUND

Typically, in audio component retail environments, audio components are available for sampling by consumers. Audio components may be standalone speakers or speakers integrated into televisions, stereos, computers, and the like. Sampling may involve the consumer turning the audio components on and off, turning the volume up and down, and choosing various types of output sounds (e.g., different music styles, movie genres, etc.). During sampling, a consumer may be interested in comparing different audio components to determine what audio quality they prefer. Often, speakers are turned on at the last volume they were used. For example, a user may first power on a first audio component and adjust the volume to a volume level they are comfortable with. The user may then power on and listen to a second audio component. The second audio component may power on at a much quieter or louder volume as compared to the first audio component. The user may then try to adjust the volume of the second audio component to be similar to the first audio component, but may not be able to achieve a similar match due to sound quality, differing volume scales, or even opinion bias after having first listened to the first audio component. This volume difference may skew a user's perception as to which audio component may provide the output performance they are looking to obtain.

Most audio components have different volume scales. Differing volume scales may occur due to variations in how different speakers produce sound and volume. These differences may be a result of varying driver types and sizes, materials and design of the drivers, the enclosure design of a speaker, crossover network quality and design, speaker sensitivity (e.g., how loud a speaker will play given an amount of power at a specific distance), efficiency (e.g., how effective a speaker converts electrical energy to sound energy), frequency response, power handling, or a combination thereof. One speaker may be able to provide a significantly louder maximum volume as compared to another. But more challenging, similar numerical or scale levels such as via a volume knob or digital scale, may produce significantly different results in actual volume measured by decibels. For example, what may be considered a “25” volume level for one speaker may be much louder than what is considered a “25” volume level for another speaker. Due to this scale dissimilarity, a user may not be able to match the volume output of speakers based on their volume levels. Further, due to varying sound quality levels between different speakers and the sound quality impacting a user's perception of the volume, a user may not be able to match the volume output of the speakers.

What is needed is a method and system which allows for a consumer to easily compare and contrast the output quality of different audio components while removing volume differences as a factor. What is needed, is a means for audio components to be matched in volume. What is needed is a method which can automatically adjust the volume of one or more second speakers to the output volume of a first speaker.

### SUMMARY

The present teachings relate to a method for automatically matching output volume of a plurality of audio components, the method comprising: a) establishing of a reference volume profile at a set of one or more predetermined conditions; b) establishing of a first volume profile for a first audio component; c) establishing of one or more second volume profiles respectively for one or more second audio components; d) performing a first mapping step of the first volume profile relative to the reference volume profile; c) performing one or more second mapping steps of the one or more second volume profiles relative to the reference volume profile; f) calculating a normalization profile over a range of sound pressure levels based upon the first mapping step and the one or more second mapping steps; and g) automatically adjusting a volume of the first audio component, the one or more second audio components, or both so the volume of the first audio component matches the volume of the one or more second audio components.

The present teachings relate to a method for automatically matching output volume of a plurality of audio components, the method comprising: a) establishing of a reference volume profile at a set of one or more predetermined conditions; b) establishing of a first volume profile for a first audio component which includes executing a reference audio file such that a plurality of test tones and a plurality of patterns associated with the reference audio file are emitted from the first audio component and detected by one or more microphones and converted into electrical signals then converted into first volume data, the first volume data is associated with a plurality of volumes of the first audio component by one or more processors of one or more media control devices and transferred for storage in the first volume profile in one or more memory storage devices of the one or more media control devices; c) establishing of one or more second volume profiles respectively for one or more second audio components which includes executing the reference audio file such that the plurality of test tones and the plurality of patterns associated with the reference audio file are emitted from the one or more second audio components and detected by one or more microphones and converted into electrical signals then converted into second volume data, the second volume data is associated with a plurality of volumes of the one or more second audio components by the one or more processors of the one or more media control devices and transferred for storage in the one or more second volume profiles in the one or more memory storage devices of the one or more media control devices; d) performing a first mapping step of the first volume profile relative to the reference volume profile, wherein the first volume data comprising the full volume range of the first audio component is correlated to a reference volume data of the reference volume profile using value-based mapping; e) performing one or more second mapping steps of the one or more second volume profiles relative to the reference volume profile, wherein the second volume data comprising the full volume range of the one or more second audio components is correlated to the reference volume data of the one or more second volume profiles using value-based mapping; f) calculating a normalization profile over a range of sound pressure levels based upon the first mapping step and the one or more second mapping steps, wherein one or more logarithmic scales associated with the first volume data in the first volume profile and the one or more second volume data in the one or more second volume profiles are converted into one or more linear scales; g) automatically adjusting a volume of the first audio component, the one or more second audio components, or both so the volume of the first audio component matches the volume of the one or more second audio components; and h) automatically confirming an outputted volume of the first audio component, the one or more second audio components, or both substantially equals or differs from the desired volume and repeating the automatically adjusting the volume if the outputted volume does not substantially equal the desired volume.

The present teachings relate to a media control device configured for adjusting a volume of one or more audio components, the media control device comprising: a) one or more storage mediums having stored therein: i) one or more volume profiles associated with one or more audio components; ii) a reference volume profile; iii) a normalization method for calculating a normalization profile over a range of sound pressure levels based on the one or more volume profiles; b) one or more processors configured to access and execute the normalization method and adjust an output volume of one or more audio components; and c) one or more audio connections configured to be in electrical signaling communication with the one or more audio components. The media control device may be configured to have stored therein, the method of the present teachings, such as in the form of computer readable instructions. The one or more processors of the media control device may be configured to access and/or execute the method of the present teachings.

The present teachings may provide for a method and system which allow for a consumer to listen to different audio components with dissimilar audio profiles and volume controls at substantially equal volumes. In this manner, the consumer is able to listen to different audio components at equal volumes and focus on and discern other aspects of the output quality of the audio components. The system and method may provide an effective manner for a consumer to listen to a subsequent audio component at substantially equal volume as a prior audio component with minimal, if any, additional effort aside from turning on the subsequent audio component.

### BRIEF DESCRIPTION OF DRAWINGS

FIG. 1 illustrates an audio control system.

FIG. 2 illustrates an audio control system.

FIG. 3 illustrates an audio control system.

FIG. 4 illustrates an architecture of a media control device.

FIG. 5 illustrates a flow of a method for automatically matching output volume.

FIG. 6 illustrates a network for an audio control system.

FIG. 7 illustrates a plurality of volume profiles.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Audio Control System

The present teachings relate to a system. The system may be referred to as an audio control system. The system may allow for two or more audio components with different audio profiles to be matched in volume output. The system may be advantageous in allowing users to compare audio output (e.g., volume, quality) of different audio components at substantially similar, if not, identical, volume levels. The system may allow for a user to change audio output via a single or a plurality of media control devices. The media control device(s) may be separate from the audio component(s), thus avoiding having to manipulate each audio component directly. The system may allow for a user to objectively change and set output volume of audio components as opposed to subjectively. The system may include one or more media control devices, microphones, audio components, processors, storage mediums, the like, or any combination thereof.

The system may include one or more media control devices. One or more media control devices may function to control one or more audio components, match output volume of one or more audio components to one or more other audio components with different volume profiles, store one or more methods therein for execution, store one or more volume profiles therein, or any combination thereof. The one or more media control devices may be in signaling communication with one or more audio components, one or more microphones, one or more controllers, one or more splitters, one or more communication hubs, one or more networks, the like, or any combination thereof. The one or more audio components may be a first audio component, one or more second audio components, or a combination thereof. Signaling communication may be electrical, wireless, wired, the like, or any combination thereof. Signaling communication may be electrical signaling communication. Signaling communication may be one-way communication, two-way communication, or both. One-way communication may mean that the media control device is only able to receive communication but not transmit or transmit communication but not receive. Two-way communication may mean that the media control device is able to both receive and transmit communication to another component. The one or more media control devices may include one or more communication means, processors, memory storage devices, one or more audio connections, or a combination thereof. One exemplary media control device may include the Multi-Audio 4K MediaHub Model MH10-ARC by Ascentric® Retail Engineering with BrightSign® built-in, which is incorporated herein by reference in its entirety.

The one or more or more media control devices may include one or more communication means. One or more communication means may function to provide for communication with one or more audio components, microphones, meters, and/or the like. Communication may be one-way or two-way. The communication means may be wired, wireless, or both. Wireless communication means may include an infrared transceiver, Bluetooth® transceiver, Wi-Fi Direct transceiver, Near Field Communication (NFC) transceiver, the like, or any combination thereof. Wired communication may include one or more HDMI-CEC connections, HDMI converters, the like, or any combination thereof. An exemplary HDMI converter may include an HDMI-CEC to RS232. One or more communication means may refer to one or more ports and/or transmitters adapted to receive a communication signal (e.g., the port and/or transmitter being in signaling communication with a wireless or wired counterpart). A communication means may be what allows for an atypical two-way communication between an audio component and a media control device. Traditionally, such communication is one-way, with the audio components able to be controlled but not transmitting information back to a controlling device. By allowing for two-way communication, a feedback loop is enabled for supporting not only a method of adjusting volume to a reference volume but also for confirming the desired volume is achieved and even further adjusting the volume. The media control device may be in communication with a plurality of audio components directly, via a splitter, the like, or a combination thereof.

The system may include one or more processors. The one or more processors may function to analyze one or more signals and/or data from one or more media control devices, convert one or more inputs into one or signals, convert one or more signals into one or more outputs, access and/or execute one or more methods (e.g., software, computer readable instructions), transfer one or more signals and/or data to one or more memory storage devices, or a combination thereof. The one or more processors may be located in one or more media control devices and/or other computing devices. One or more processors may be part of one or more servers (e.g., remote or cloud server). One or more processors may include a single or a plurality of processors. One or more processors may be in communication with one or more other processors. The one or more processors may or may not be cloud-based (e.g., remote from other portions of the system). For example, some of the processing may occur remotely if the media control device is in communication with the Internet via a network. The one or more processors may function to process data, execute one or more algorithms to analyze data, or both. Processing data may include receiving, transforming, outputting, executing, the like, or any combination thereof. One or more processors may be part of one or more hardware, software, systems, or any combination thereof. One or more hardware processors may include one or more central processing units, multi-core processors, front-end processors, the like, or any combination thereof. The one or more processors may be non-transitory. The one or more processors may be referred to as one or more electronic processors. The one or more processors may convert data signals to data entries to be saved within one or more storage mediums. A data signal may be a signal associated with an input from a user interface, such as a controller. A data entry may be an entry stored within one or more databases. The one or more processors may access one or more algorithms, processes, and/or methods to analyze one or more data entries and/or data signals. The one or more processors may access one or more algorithms saved within one or more memory storage devices. The one or more processors may access one or more normalization methods from one or more memory storage devices. The one or more processors may execute one or more normalization methods. The one or more processors may adjust an output volume of one or more audio components. The one or more processors may automatically adjust the output volume of one or more audio components.

The system may include one or more memory storage devices (e.g., electronic memory storage device). The one or more memory storage devices may store data (e.g., volume profiles, reference volume, reference audio files, etc.), databases, computer readable instructions, algorithms, processes, methods, or any combination thereof. The one or more memory storage devices may include one or more hard drives (e.g., hard drive memory), chips (e.g., Random Access Memory “RAM)”), discs, flash drives, memory cards, the like, or any combination thereof. The one or more memory storage devices may include one or more cloud-based storage devices. The data stored within one or more memory storage devices may be compressed, encrypted, or both. One or more memory storage devices may be located within one or more media control device, other computing devices, remote from the media control device, servers (e.g., remote or cloud server), the like, or any combination thereof. One or more memory storage devices may be referred to as one or more electronic memory storage devices. One or more memory storage devices may be non-transitory. One or more memory storage devices may store one or more data entries in a native format, foreign format, or both. One or more memory storage devices may store data entries as objects, files, blocks, or a combination thereof. The one or more memory storage devices may include one or more algorithms, methods, rules, databases, data entries, the like, or any combination therefore stored therein. The one or more memory storage devices may store data in the form of one or more databases. The one or more memory storage devices may include one or more reference volume sets, volume profiles, reference audio files, normalization methods, computer readable instructions for executing one or more methods or portions thereof, or any combination stored therein. One or more memory storage devices may include one or more instruction algorithms. One or more instruction algorithms may contain computer readable instructions for generating one or more outputs from one or more audio components. One or more computer readable instructions may be configured to instruct a media control device, such that the media control device is able to instruct and direct one or more audio components. One or more computer readable instructions may be executable by one or more processors. One or more control algorithms may be stored within one or more servers, media control devices, or both.

The system may include a plurality of audio components. The audio components may function to output sound, such as by converting electrical signals into sound. The one or more audio components may have a volume control. A volume control may function to adjust the volume of an audio component (e.g., turning volume up to be loader, down to be quieter). A volume control may be discrete, incremental, or both. The audio components may have an output of about 20 Hz or more, about 30 Hz or more, about 40 Hz or more, or even about 50 Hz or more. The audio components may have an output of about 15 kHz or more, about 18 kHz or more, about 20 kHz or more, or even about 25 kHz or more. The audio components may have an output of about 20 Hz or less to about 20 kHz or more. One audio component may have different output capabilities than one or more other audio components. The plurality of audio components may include a first audio component and one or more second audio components. The plurality of audio components may include a reference audio component. A reference audio component may be separate from or be one of the first audio components or second audio components. One or more second audio components may include one or more, two or more, or even five or more audio components. One or more second audio components may include twenty or less, fifteen or less, or even ten or less audio components. One or more audio components may be standalone audio components or audio components integrated into other devices. Standalone audio components may include headphones, woofers, subwoofers, midrange speakers, tweeters, full range speakers, sound bars, outdoor speakers, ceiling speakers, standing speakers, surround speakers, smart speakers, wireless (e.g., Bluetooth® speakers), the like, or any combination thereof. Other devices which may include audio components integrated therein may include televisions, computers, monitors, mobile phones, telephones, mobile tablets, vehicles, helmets, furniture, radios, children's toys, the like, or any combination thereof.

The system may include one or more microphones. One or more microphones may function to determine sound of an ambient environment, record output of one or more audio components, cooperate in establishing one or more volume profiles, the like, or any combination thereof. One or more microphones may be separate from or integrated into one or more media control devices, meters, or both. One or more microphones may be in electrical signaling communication with one or more media control devices. One or more microphones may be in one or two-way communication with one or more media control devices, audio components, or both. The one or more microphones may be configured to receive a reference volume from an ambient environment, reference audio component (e.g., a speaker which sets the reference volume), or both. An ambient environment may be relative to where an audio component is physically present. The one or more microphones may be configured to receive an output volume from one or more audio components. Configured may mean being set at a predetermined distance and/or angle from one or more audio components. A single microphone may be associated with a plurality of audio components or a single audio component. The one or more microphones may cooperate in establishing one or more volume profiles. For example, one or more microphones may be situated at a predetermined distance and/or angle from one or more audio components while each audio component outputs one or more test sounds from a reference audio file. The one or more microphones may be configured to continuously or intermittently receive and monitor a reference volume, such as from an ambient environment. Types of microphones may include condenser microphones, omnidirectional microphones, dynamic microphones, ribbon microphones, and/or the like. The microphones may be USB, XLR, and/or the like.

The system may include one or more meters. The one or more meters may function to detect a volume, pressure, or other quality of an incoming sound wave from an audio component. The one or more meters may be separate from, integrated with, or have as part of, one or more microphones, media control devices, or a combination thereof. The one or more meters may be in electrical signaling communication with one or more microphones, media control devices, or both. If separate from a microphone, the one or more meters may be positioned near or with the one or more microphones or distanced therefrom. One or more meters may include one or more sound pressure level (“SPL”) meters, directional sound level meters, frequency analyzers, oscilloscopes, vibration meters, reverberation time meters, time delay spectrometry meters, the like, or a combination thereof. The one or more measured traits of the sound wave may be stored as a numerical value within the one or more volume profiles.

The system may include one or more controllers. One or more controllers may function as one or more user interfaces to adjust the volume of one or more audio components via one or more media control devices. The one or more controllers may allow for a user to control a media device controller, audio components, or both from a distance. The one or more controllers may be in wireless or wired communication with one or more media control devices. Wireless communication may infrared, Bluetooth®, Wi-Fi, Wi-Fi Direct, Near Field Communication (NFC), the like, or any combination thereof. The one or more controllers may include one or more interactive elements. Interactive elements may include buttons, graphic user interface objects, and/or the like. The one or more controllers may include one or more remote controllers, graphic user interfaces, mobile devices (e.g., smart phone, tablet, etc.), the like, or any combination thereof. The one or more controllers may be configured to select a specific audio component to power on, power off, increase a volume thereof, decrease a volume thereof, select example audio for listening (e.g., music or sounds) therefrom, the like, or a combination thereof.

The system may include one or more computing devices. The one or more computing devices may function to control a media control device, convert one or more inputs to signals, receive and transmit one or more signals, execute one or more computer-readable instructions, or any combination thereof. The one or more computing devices may include and/or be in communication with one or more processors, memory storage devices, servers, networks, user interfaces, media control devices, communication hubs, other computing devices, the like, or any combination thereof. The one or more or more computing devices may communicate via one or more networks, servers, the like, or any combination thereof. The one or more computing devices may include one or more servers, processors, and/or the like separate from and/or part of a media control device. All computing and execution of the method may occur locally at one or more media control devices or may incorporate the use of one or more external computing devices. An external computing device may include a computing device in communication with the media control device either directly or via a network. A computing device may include one or more servers including one or more memory storage devices and processors.

The system may be integrated into, in communication with, and/or include one or more networks. One or more media control devices, computing devices, or both may be in selective communication with one or more networks. One or more networks may allow for a media control device to communicate with one or more servers. One or more networks may allow for two or more other separate networks to communicate indirectly. The one or more networks may be formed by placing two or more computing devices in communication with one another. One or more networks may include one or more communication hubs (e.g., routers, wireless routers, firewalls, switches, access points), computing devices, processors, databases, servers, memory storage devices, media devices, the like, or any combination thereof. One or more computing devices of the system may be directly connected to one another without the use of a communication hub. One or more networks may be connected to one or more other networks. One or more networks may include one or more local area networks (“LAN”), wide area networks (“WAN”), virtual networks (“VLAN”), virtual private network (“VPN”), intranet, Internet, cellular networks, the like, or any combination thereof. A network may allow for some of the computing (e.g., analysis) to occur remotely, on faster processors, with access to larger memory storage devices, the like, or any combination thereof.

The system may benefit from the media device, media control device, identifiers, user interfaces, network, and other teachings as disclosed in U.S. Pat. No. 11,544,696, incorporated herein by reference in its entirety. These teachings may be integrated or part of the system components discussed herein.

### Method for Volume Matching

The present teachings may relate to a method for volume matching. The method may be a method for automatically matching output volume of a plurality of audio components. The method may allow for automatically matching the output volume of different audio components. The method may be advantageous in matching output volume of audio components having different volume profiles. The method may include establishing a reference volume, establishing one or more volume profiles, performing one or more mapping steps, calculating a normalization profile, adjusting volume of one or more audio components, confirming a desired volume, readjusting the volume of one or more audio components, monitoring sound (e.g., ambient sound) in an ambient environment, or any combination thereof. The method may be stored as one or more sets of computer readable instructions on one or more media control devices, computing devices, memory storage mediums, the like, or any combination thereof. The method may be accessible and executable by one or more processors of one or more media control devices, computing devices, or both.

The method may include establishing a reference volume profile. A reference volume profile may function to provide a calibrated reference audio file to compare and/or normalize other volume profiles to. Establishing may occur upon receiving a signal from one or more audio components (e.g., reference audio component), computing devices, a media control device, a controller, a microphone, or any combination thereof. The reference volume profile may be established at a set of one or more predetermined conditions. One or more predetermined conditions may include one or more full or partial (e.g., semi) anechoic chambers, one or more ambient environments (e.g., in lieu of anechoic), one or more calibrated microphones at a predetermined location, a sound pressure level, a reference audio file, or a combination thereof. Predetermined location may mean a predetermined distance and/or direction from one or more audio components. The audio component for the reference volume profile may be a reference audio component. The reference audio component may be separate from or be one of the first audio component and one or more second audio components. The reference audio file may be initiated and emitted from one or more audio components. The reference audio component may generate one or more sounds (e.g., reference sounds) by emitting the reference audio file. The one or more reference sounds may be captured as sound waves by one or more microphones (e.g., calibrated microphone), meters, or both such as at the one or more predetermined conditions. One or more microphones (e.g., calibrated) may receive the sound from the one or more reference audio components and convert into an electrical signal. Sound pressure level may be measured with a meter, such as a sound pressure level (“SPL”) Meter. The one or more microphones, meters, or both may convert the incoming sound waves into one or more signals (e.g., electrical signal). The microphone, the meter, or both may relay one or more converted electrical signals associated with the reference audio file to one or more processors. The one or more processors may transmit the sound as signals to one or more memory storage devices for storage. The one or more processors and/or memory storage devices may be part of or separate from the media control device. Establishing a reference volume profile may be initiated by a user, automatically upon detecting a changed condition, automatically at repeated time intervals, or any combination thereof. For example, a user may initiate a media control device to commence the step of establishing a reference volume. As another example, the step may be automatically executed at predetermined and repeated time intervals, such as daily, twice daily, weekly, monthly, and/or the like. And as a further example, the step may be automatically executed upon sensing a changed condition, such as the addition of a new audio component to the system, removal of an existing audio component to the system, physical movement of a microphone of the system, the like, or any combination thereof. The changed condition may be sensed by a media control device (e.g., detecting a change with one or more communication means, inputs). A reference volume may also be understood as a reference volume profile. A reference volume may be understood as a specific volume level within the reference volume profile. In other words, the reference volume profile may not include just a single tone at a single volume but a number of tones and/or patterns at varying volumes. The reference volume profile may also associate each increasing volume and/or sound pressure level with an incremental number (e.g., 0 decibels at level 0, 10 decibels at level 20, 40 decibels at level 80, 100 decibels at level 200, etc.). Sound pressure level and volume may be used synonymously in these teachings.

The reference sound may be generated from a reference audio file. The reference audio file may generate an audible output from one or more reference audio components which includes one or more test tones, patterns of tones (e.g., patterns for the test tones), or both for testing a full and/or partial audio range of one or more audio components. The reference audio file may be used for one or both establishing a reference volume and establishing one or more volume profiles. The reference audio file may be one or more computer readable instructions, recordings, or both. The reference audio file may be accessed from one or more memory storage devices by one or more processors, transmitted to one or more audio components (e.g., reference audio component, first audio component, second audio component), audibly generated by one or more audio components, or any combination thereof.

The method may include establishing one or more volume profiles. Establishing the one or more volume profiles may be automatically performed. Establishing one or more audio profiles may include establishing a first volume profile for a first audio component, establishing one or more second volume profiles respectively for one or more second audio components, or both. Establishing may occur upon receiving a signal from one or more audio components, computing devices, a media control device, a controller, a microphone, a meter (e.g., media control device receiving the signal); upon a user instructing the media control device; upon establishing a reference volume profile; initiating a reference audio file on an audio component; upon detecting connection the audio component into the system; the like; or any combination thereof. Establishing a volume profile may occur before or after connecting one or more audio components into the system. One or more volume profiles may include a first volume profile, one or more second volume profiles, or a combination thereof. A first volume profile may be for a first audio component. One or more second volume profiles may be for one or more second audio components. A first volume profile may be different than or same as one or more second volume profiles (e.g., have different profiles). Establishing a volume profile may include determining a volume range of one or more audio components. Executing the reference audio file may be executed to determine the full volume range. Establishing a volume profile may include determining what type of volume control method is utilized by one or more audio components. The volume control method may be a discrete (i.e., absolute) volume control, an incremental volume control, or both. Determining the volume control method may be determined when increasing the volume of the audio component when executing the audio reference file and picking up the volume increase via a microphone, meter, and/or the like. The outputted audio reference file may be analyzed to determine if the volume increase is discrete (e.g., volume jumping by increments) or incremental (e.g., volume increasing continuously). The media control device via the electrical signaling communication may also be able to determine the type of volume control via accessing the programming of the audio component and/or determining how volume is adjusted (e.g., knob/dial turn may be incremental versus button may be discrete). Establishing a volume profile may include recording a linear volume level of one or more audio components. Establishing a volume profile may include testing a reference audio file on one or more audio components, such as the first and one or more second audio components. The reference audio file may be accessed from one or more memory storage devices from one or more processors, transmitted to one or more audio components (e.g., first and/or one or more second audio components), or both. The reference audio file may be initiated and emitted from one or more audio components (e.g., first and/or one or more second audio components). The same reference audio file may be the same as the reference audio file for the reference audio component and establishing the reference audio volume. The first audio component and one or more second audio components may utilize the same reference audio file. One or more microphones (e.g., calibrated) may receive (e.g., detect) the sound as sound waves from the one or more audio components and convert into an electrical signal. Sound pressure level may be measured with a meter, such as a sound pressure level (“SPL”) Meter. The microphone, meter, or both may transmit the one or more signals to one or more processors. The one or more processors may transmit the detected sound and/or pressure as signals to one or more memory storage devices for storage. The recording of the reference audio file emitted from a first and/or one or more second audio components may be referred to as a volume profile. The volume profiles may be stored in one or more volume profile databases. A volume profile of a first audio component may be referred to as a first volume profile. A volume profile of one or more second audio components may be referred to as one or more second volume profiles. The volume profile of each audio component of the system may be established independently as opposed to simultaneously. This may allow for the sound from the audio component to be clearly detected by a microphone without interference from another audio component of the system. As an example, establishing one or more volume profiles may include executing a reference audio file such that a plurality of test tones and a plurality of patterns associated with the reference audio file are emitted from the one or more audio components and detected by one or more microphones and converted into electrical signals then converted into volume data, the volume data is associated with a plurality of volumes of the one or more audio components by one or more processors of one or more media control devices and transferred for storage in the one or more volume profiles in one or more memory storage devices of the one or more media control devices.

The method may include performing one or more mapping steps. Mapping (e.g., mapping step) may be useful in correlating one or more outputted volume levels (e.g., volume data) from one or more audio components and/or one or more volume profiles to outputted volume levels of a reference volume profile, reference audio component, and/or reference volume profile. For example, a first audio component volume level 10 may output the same sound pressure level (SPL) or Decibels as the reference audio component at volume level 15. Mapping may include mapping one or more volume profiles relative to one or more reference volume profiles. A mapping step may include mapping one or more volume profiles of one or more audio components. One or more mapping steps may include a first mapping step of the first volume profile of the first audio component relative to the reference volume profile. One or more mapping steps may include one or more second mapping steps of the one or more second volume profiles of the one or more second audio components relative to the reference volume profile. Mapping may be automatically performed. Mapping may be performed upon one or more volume profiles being established. Mapping may be automatically performed for an audio component after a reference volume (e.g., reference volume profile) of a reference audio component and volume profile of the audio component are established. Mapping may be executed by one or more processors. Mapping may include one or more processors accessing one or more mapping algorithms from one or more memory storage devices. One or more mapping steps may include a first mapping step, one or more second mapping steps, or a combination thereof. Mapping may include correlating a volume range (e.g., full volume range) of one or more audio components to a reference volume profile. Correlating may mean finding and matching an output volume of an audio component to a reference volume. The one or more mapping steps may comprise a value-based mapping. Value-based mapping may include matching recorded volume levels in one volume profile to a same or similar volume level in a reference volume profile. Mapping may include a processor transmitting correlations of a volume output of an audio component relative to a reference volume to a memory storage device for storage. Mapped levels may be stored in one or more mapping databases. A mapping database may be the same or separate from a volume profile database. For example, the mapping database may include one or more columns, rows, or other data fields and/or associations having the different volume levels of a volume profile of an audio component and the associated (e.g., mapped, correlated) different volume levels of a reference volume. Once a volume profile is mapped or an associated mapped profile is generated, it may be referred to as a mapped profile. A first volume profile once mapped may be referred to as a first mapped volume profile, a first volume profile, a first volume profile that is mapped, the like, or any combination thereof. A second volume profile once mapped may be referred to as a second mapped volume profile, a second volume profile, a second volume profile that is mapped, the like, or any combination thereof.

The method may include calculating a normalization profile. A normalization profile may function to convert one or more volume profiles, mapped profiles, or both into a similar scale. The scale may be a scale relative to the reference volume profile, the first volume profile, the one or more second volume profiles, the mapped profile(s), a default profile, the like, or any combination thereof. Different audio components with different volume profiles may each exhibit different audio ranges and capabilities. Sound is typically perceived by humans as logarithmic and not linear. Thus, different volume profiles of different audio components may have different logarithmic scales. Normalizing a profile for each audio component may be useful to correlate common volume levels across varying volume profiles, mapped profiles, or both. The normalization profile may be over a range of sound pressure levels. The normalization profile may be based upon the first mapping step and the one or more second mapping steps. Calculating a normalization profile may comprise determining a logarithmic audio scale of a first audio component, one or more second audio components, or both. A logarithmic audio scale may be of a volume profile, mapped profile, or both. Calculating a normalization profile may comprise converting a logarithmic scale of one or more audio components to a substantially linear audio scale. A plurality of volume levels in one or more volume profiles may be detected and stored as a logarithmic audio scale. The conversion to a linear audio scale may include any traditional means of conversion. The conversion from logarithmic to linear may include raising the base of the logarithm to the power of each data point collected. Calculating a normalization profile may comprise normalizing the substantially linear audio scale. Normalizing may include linear transformation, such as min-max normalization, Z-score normalization, decimal scaling normalization, the like, or any combination thereof. Calculating a normalization profile may be executed by one or more processors, media control device, or both. The normalization profile may be calculated upon a volume profile being completed, upon a mapped volume profile being completed, or both. The one or more processors may access one or more normalization algorithms from one or more memory storage devices. The one or more processors may transmit one or more normalization profiles to one or more memory storage devices for storage. A normalization profile may be created per audio component and associated volume profile. A normalization profile may include a first normalization profile, one or more second normalization profiles, or both.

The method may include automatically adjusting a volume. The volume may be adjusted automatically. The volume of the first audio component, one or more second audio components, or both may be adjusted. The volume may be adjusted such that the volume of the first audio component matches the volume of the one or more second audio components and/or vice versa. The volume may be adjusted to a requested and/or desired volume. The volume may be adjusted by one or more media control devices. The volume may be automated adjusted by one or more media control devices. The volume may be adjusted based on input into one or more controllers, media control devices, audio components, or any combination thereof. The input may be a request and/or desired volume. For example, a user may select a requested and/or desired volume on a controller or media control device. The volume may be adjusted to match the volume of the audio component which most recently emitted sound. For example, when a user turns on a first audio component after a second audio component was playing, the first audio component may be adjusted to match the volume of the second audio component. For example, when a user turns on a second audio component after a first audio component was playing, the second audio component may be adjusted to match the volume of the first audio component. As another example, a user may first turn on a first or second audio component and then adjust (e.g., input) a volume to a requested and/or desired volume via a controller and/or media control device. Then to continue the example, the user may then turn on a different first or second audio component and the volume may be automatically adjusted to match the requested, desired, and/or outputted volume of the previously playing first and/or second audio component. The volume may be adjusted prior to sound being emitted such that when sound first starts to be emitted for the latter playing audio component (e.g., first and/or second) it matches the volume of the sound playing from the previously playing audio component (e.g., first and/or second). The volume may be automatically adjusted by a media control device, one or more processors, or both. The adjusted, requested, and/or desired volume may be stored within one or more memory storage devices.

The method may include confirming a desired volume of an audio component compared to a desired reference volume. The audio component may be a first audio component, one or more second audio component, or a combination thereof. The audio component may be the audio component powered on, selected by a user to emit sound, or both. The method may include determining if the desired volume matches the desired reference volume, previously emitted volume, or both. A media control device, processor, or both may receive feedback from one or more audio components, a microphone, a meter, or a combination thereof as to what volume of sound the audio component is outputting. The media control device, processor, or both may confirm if the outputted volume of sound matches the desired reference volume. The media control device, processor, or both may confirm if the volume to be output matches the desired reference of sound. In other words, confirmation may confirm the resulting volume being emitted matches the desired volume and/or the programmed volume to be emitted matches the desired volume. The method may include automatically adjusting the volume of the audio component (e.g., first and/or one or more second audio components) to achieve the desired volume. In other words, if the desired volume is not substantially equal to (e.g., matches) the desired reference volume, the method may include adjusting (e.g., automatically) the volume of the first audio component, the one or more second audio components, or both to achieve the desired volume. For example, in the instance the resulting volume after the initial adjustment and after comparison does not match the desired reference volume the volume may be automatically adjusted. Confirming a desired volume may include one or more processors accessing one or more confirmation algorithms from one or more memory storage devices. Confirming a desired volume may include the one or more processors executing the one or more confirmation algorithms. The confirmation algorithm may compare a received outputted volume to a reference volume and determine if substantially equal or different. If different, the confirmation algorithm may determine the volume level difference and adjust based on the difference level (increase or decrease the number of volume levels) and/or adjust based on the reference volume level. Confirming a desired volume may include the one or more processors receiving a current volume from an audio component and comparing to a desired volume.

The method may include monitoring a reference volume from an ambient environment. Monitoring for a reference volume in an ambient environment may allow for volume profiles, mapping profiles, normalization profiles, or a combination thereof to be adjusted for changing levels in ambient noise. For example, a retail setting may have overall quiet ambient noise during the day on weekdays as opposed to evenings on weekdays or during weekends. In real-time, the volume of one or more audio components may be adjusted based on the monitored reference volume. Monitoring may be continuous or intermittent. Monitoring may be by one or more microphones, meters, or both. One or more microphones, meters, or both may monitor for a reference volume of an ambient environment. The one or more microphones, meters, or both may transmit the reference volume to one or more media control devices, processors, or both. The one or more media control devices, processors, or both may automatically adjust one or more volume profiles, mapping profiles, normalization profiles, or a combination thereof to account for the ambient environment.

### Illustrative Examples

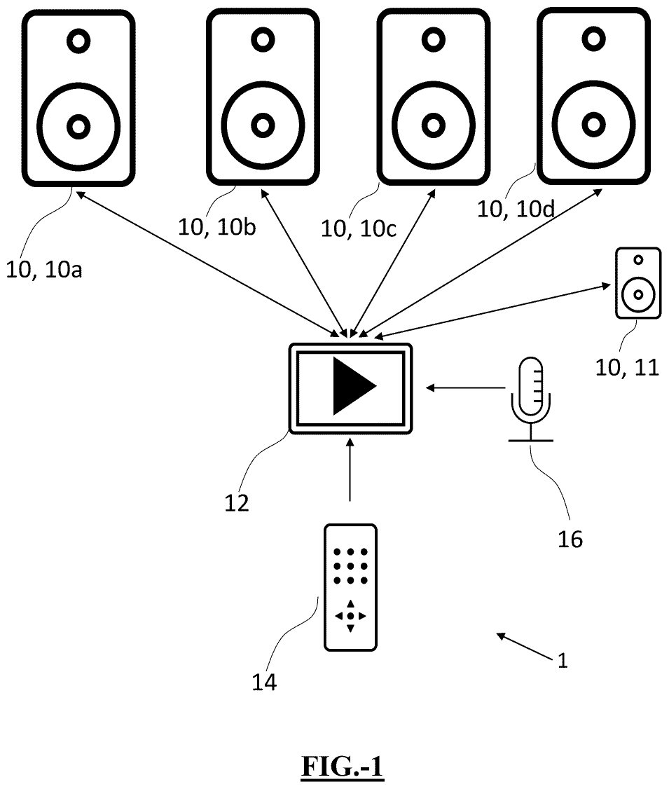

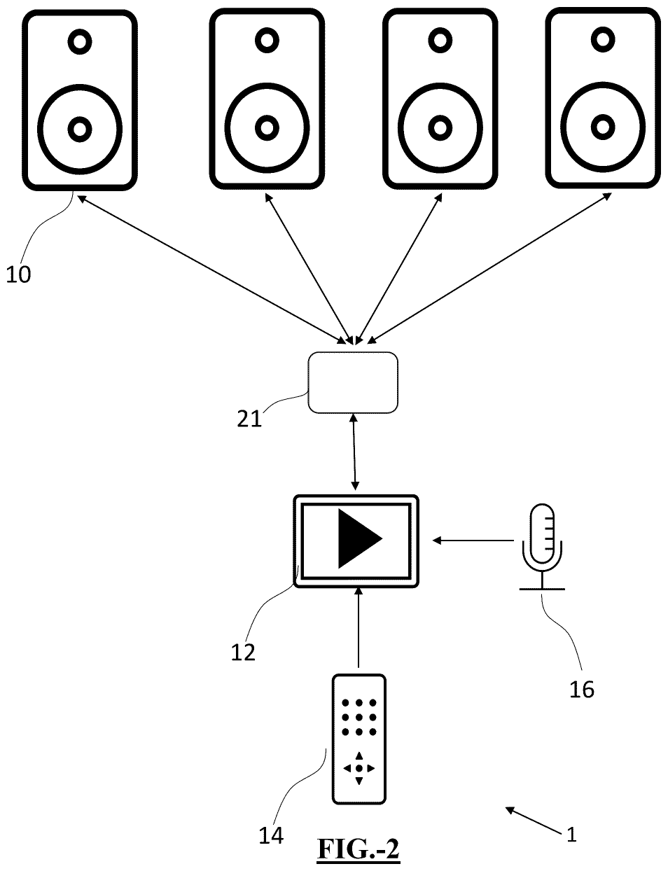

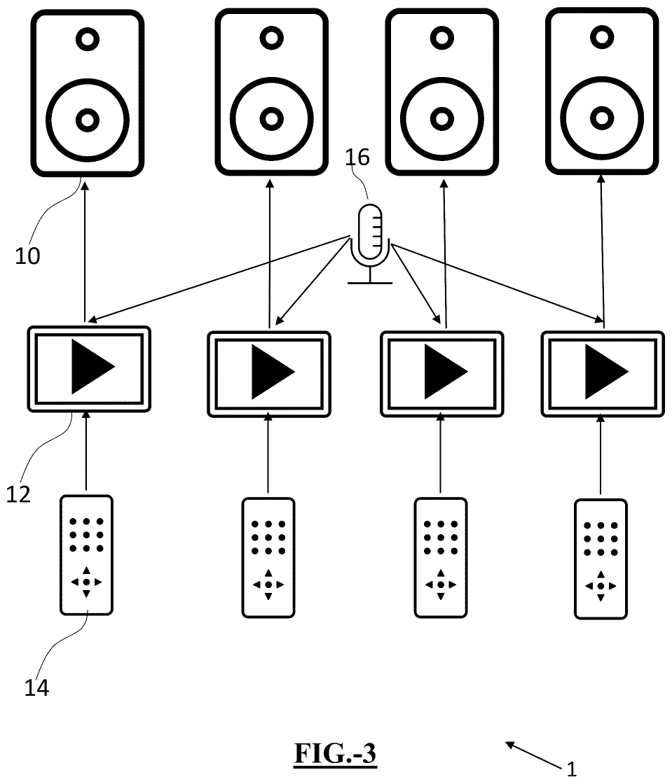

FIGS. 1, 2, and 3 illustrate exemplary systems 1 and the system I configurations of a media control device 12 relative to one or more audio components 10. A single media control device 12, such as illustrated in FIG. 1 or 2, may control a plurality of audio components 10. The audio components 10 may include a plurality of audio components (e.g., two or more), such as a first audio component 10a, a second audio component 10b, a third audio component 10c, a fourth audio component 10d, and/or so forth, such as illustrated in FIG. 1. The plurality of audio components 10 may include a reference audio component 11, such as illustrated in FIG. 1. The audio components 10 may be in direct communication with a media control device 12 or in communication via a splitter 21. In the alternative, each audio component 10 may be controlled by an exclusive media control device (e.g., dedicated media control device), such as illustrated in FIG. 3. The media control device 12 may be in communication with one or more microphones 16. The media control device 12 or the audio component 10 may be controlled by a controller 14. A single controller 14 may control a plurality of audio components 10, such as illustrated in FIGS. 1 and 2, or control a single audio component 10, such as illustrated in FIG. 3. A single controller 14 operating a single audio component 10 may be referred to as an exclusive or dedicated controller.

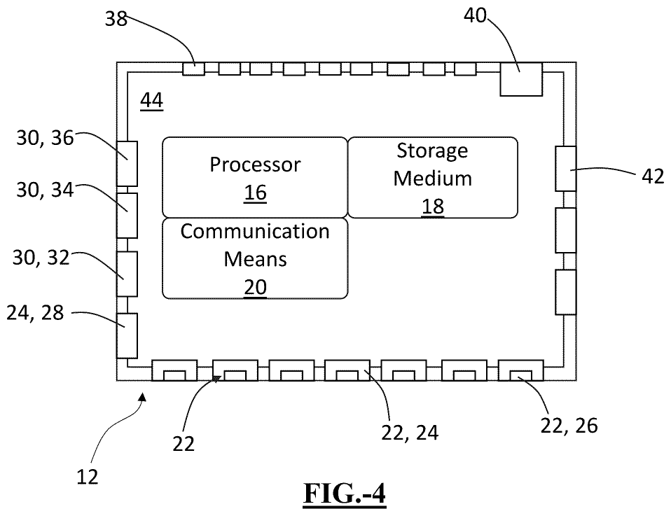

FIG. 4 illustrates an interior of a media control device 12. The media control device 12 includes a processor 16 and storage medium 18. The media control device 12 includes one or more communication means 20. The media control device 12 includes a plurality of outputs 22. The outputs 22 may include one or more HDMI ports 24 and one or more audio ports 26. An HDMI port 24 may include a video output 28. The media control device 12 includes a plurality of inputs 30. The inputs 30 may include an SD media card input 32, a network input 34, a USB input 36, and/or the like. The media control device 12 includes a plurality of control ports 38. The media control device 12 includes a power input 40. The media control device 12 includes a plurality of input/output ports 42 (e.g., RS-232, RS-485). Each of the components of the media control device 12 may be in communication with one another via a board 44 (e.g., circuit board, printed circuit board).

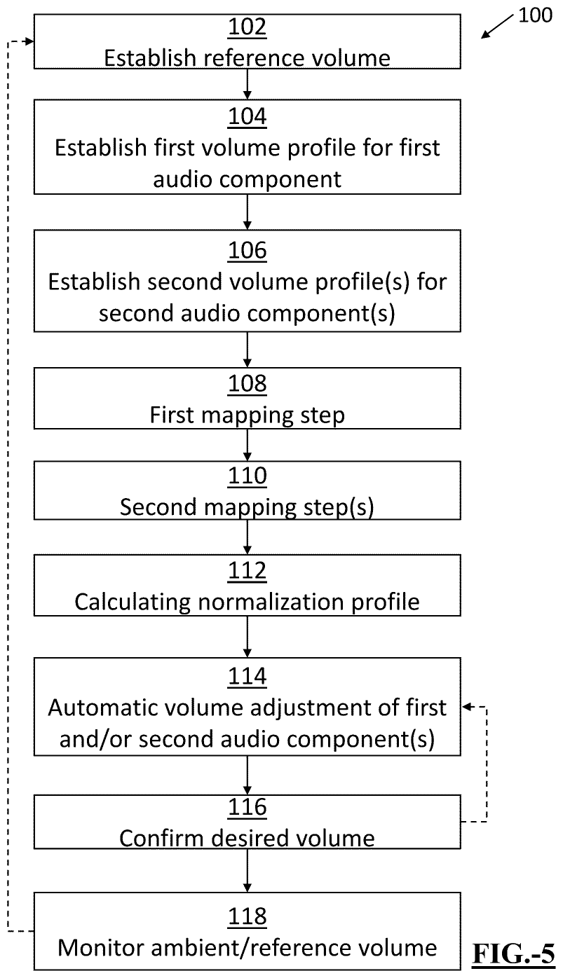

FIG. 5 illustrates a method 100 for automatically matching output volume of a plurality of audio components. The method may include establishing a reference volume profile 102. After establishing a reference volume profile, one or more volume profiles may be established. A first volume profile may be established 104 and one or more second volume profiles may be established 106. The method may include a first mapping step 108. During the mapping step 108, the first volume profile may be correlated with the reference volume profile. The method may include one or more second mapping steps 110. During one or more second mapping steps 110, the one or more second volume profiles may be correlated with the reference volume profile. The method may include calculating a normalization profile 112. The method may then include automatic volume adjustment of one or more first and/or second audio components 114, such as to a desired volume. The method may include confirming the desired volume is being output by the first and/or second audio component 116. If the output volume does not match the desired volume, the method may include repeat the automatic adjustment 114. The method may include monitoring the ambient volume 118. If the ambient volume changes, the method may include automatically repeating establishing the reference volume. The method may repeat at the automatic adjustment step 114 at any time a user changes the desired volume and/or the desired audio component for outputting a volume.

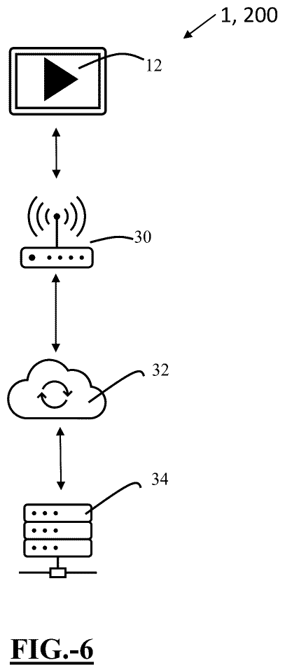

FIG. 6 illustrates a potential network 200 of the system 1. The network 200 includes one or more media control devices 12. The media control device 12 may be in communication with a communication hub 30. The communication hub 30 may be in communication with a network 32, for example, the Internet. The network 32 may be in communication with one or more servers 34. The one or more servers 34 may include one or more processors and memory storage devices. The network 200 of FIG. 6 may be integrated (e.g., combined) with the system 1 as shown in FIGS. 1 through 3. For example, the media control device 12 of FIG. 6 may be a media control device 12 as shown in FIGS. 1 through 3.

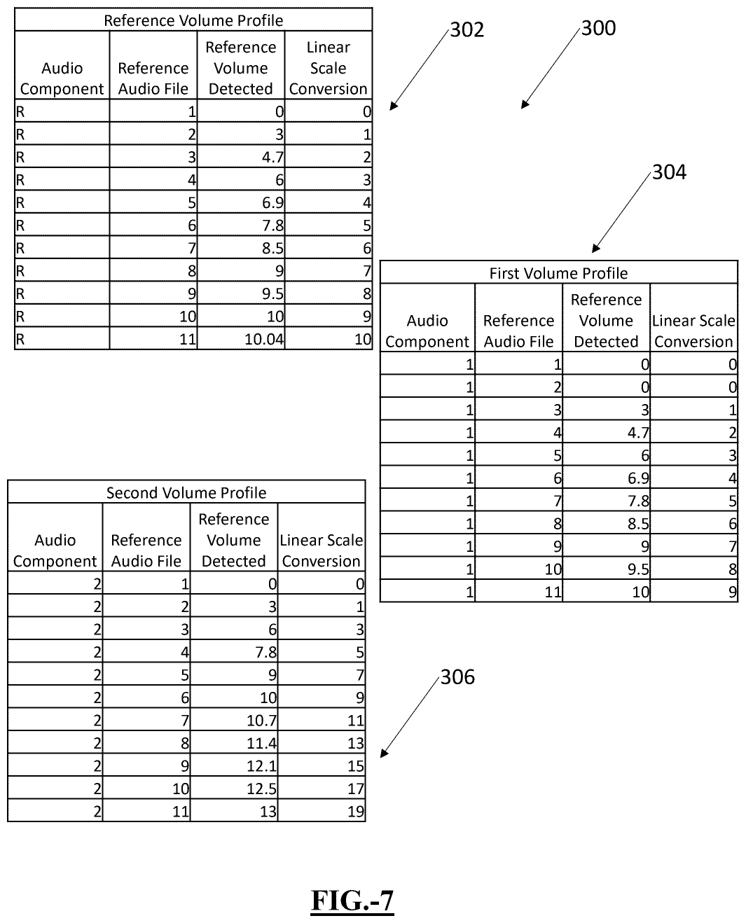

FIG. 7 illustrates exemplary one or more databases 300 storing one or more volume profiles. The volume profiles may include a reference volume profile 302, a first volume profile 304, and one or more second volume profiles 306. Each profile 302 may capture the audio component; a potential instruction or other identifier of an audio reference file related to a specific volume level; the detected volume output; and a linear scale conversion of the volume output. The detected volume output and/or the converted volume output of a first volume profile and/or second volume profile may then be correlated to a detected volume output, the converted volume output, or any other identifier of a reference volume profile. The numerical values depicted in the profiles are only exemplary and may not accurately depict measured values, a logarithm scale, a linear scale, capability of audio components, and/or the like.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. A method for automatically matching output volume of a plurality of audio components, the method comprising:
a) establishing of a reference volume profile at a set of one or more predetermined conditions;
b) establishing of a first volume profile for a first audio component;
c) establishing of one or more second volume profiles respectively for one or more second audio components;
d) performing a first mapping step of the first volume profile relative to the reference volume profile;
e) performing one or more second mapping steps of the one or more second volume profiles relative to the reference volume profile;
f) calculating a normalization profile over a range of sound pressure levels based upon the first mapping step and the one or more second mapping steps; and
g) automatically adjusting a volume of the first audio component, the one or more second audio components, or both so the volume of the first audio component matches the volume of the one or more second audio components.

2. The method of claim 1, wherein the first volume profile has a different profile from the one or more second volume profiles.

3. The method of claim 2, wherein the establishing of the reference volume, the first volume profile, the one or more second volume profiles, or any combination thereof are automatically performed upon a user instructing one or more media control devices, upon the one or more media control devices receiving a signal from a respective audio component, upon establishing the reference volume profile, upon the one or more media control devices detecting connection of the respective audio component, or a combination thereof.

4. The method of claim 3, wherein the performing of the first mapping step, the one or more second mapping steps, or any combination thereof are automatically performed upon the first volume profile, the one or more second volume profiles, or both being established.

5. The method of claim 4, wherein the automatically adjusting the volume is performed by the one or more media control devices.

6. The method of claim 5, wherein the one or more media control devices are in electrical signaling communication with the first audio component, the one or more second audio components, or a combination thereof.

7. The method of claim 5, wherein the one or more media control devices include one or more processors and one or more memory storage devices; and
wherein one or more media control devices include or are in electrical signaling communication with one or more microphones, meters for measuring sound pressure level, or both.

8. The method of claim 1, wherein the establishing of the first volume profile, the one or more second volume profiles, or both comprise determining a full volume range of the first audio component, the one or more second audio components, or both.

9. The method of claim 8, wherein the establishing of the first volume profile, the one or more second volume profiles, or both comprise determining if the first audio component, the one or more second audio components, or both have a discrete volume control, an incremental volume control, or both.

10. The method of claim 1, wherein once the volume is adjusted, the method includes automatically confirming a desired volume of the first audio component, the one or more second audio components, or both compared to a desired reference volume and determining if the desired volume matches the desired reference volume.

11. The method of claim 10, wherein if the desired volume is not substantially equal to the desired reference volume, the method includes automatically adjusting the volume of the first audio component, the one or more second audio components, or both to achieve the desired volume.

12. The method of claim 8, wherein performing the first mapping step, the one or more second mapping steps, or both comprise correlating the full volume range of the first volume profile of the first audio component, the one or more second volume profiles of the one or more second audio components, or both to the reference volume profile; and
wherein the first mapping step and the one or more second mapping steps are value-based mapping.

13. The method of claim 12, wherein the calculating a normalization profile comprises converting a plurality of volume levels of the first volume profile, the one or more second volume profiles, or both detected and stored as a logarithmic audio scale into a substantially linear audio scale.

14. The method of claim 1, wherein the one or more predetermined conditions includes one or more:
one or more full anechoic chambers;
one or more partial anechoic chambers;
one or more ambient environments;
one or more calibrated microphones at a predetermined location;
one or more sound pressure levels;
one or more reference audio file including a plurality of test tones and patterns for testing full audio range of one or more audio components; or
any combination thereof.

15. The method of claim 1, wherein the establishing of the first volume profile includes executing a reference audio file such that a plurality of test tones and a plurality of patterns associated with the reference audio file are emitted from the first audio component; and
wherein the establishing of the one or more second volume profiles includes executing the reference audio file such that the plurality of test tones and the plurality patterns associated with the reference audio file are emitted from the one or more second audio components.

16. The method of claim 7, wherein the one or more microphones are configured to receive output in a form of sound emitted from the first audio component, the one or more second audio components, or both such that the first volume profile, the one or more second volume profiles, or both can be established.

17. The method of claim 16, wherein the one or more microphones are configured to receive a reference volume to establish or update the reference volume profile as an ambient environment in which the audio component and the one or more second audio components are physically present; and
wherein the one or more microphones are configured to continuously or intermittently receive and monitor the reference volume from the ambient environment such as to in real-time adjust a volume of the first audio component, the one or more second audio components, or both to meet the achieve a desired volume.

18. A method for automatically matching output volume of a plurality of audio components, the method in a form of computer readable instructions, the method comprising:
a) establishing of a reference volume profile at a set of one or more predetermined conditions;
b) establishing of a first volume profile for a first audio component which includes executing a reference audio file such that a plurality of test tones and a plurality of patterns associated with the reference audio file are emitted from the first audio component and detected by one or more microphones and/or one or more sound pressure level meters and converted into electrical signals then converted into first volume data, the first volume data is associated with a plurality of volumes of the first audio component by one or more processors of one or more media control devices and transferred for storage in the first volume profile in one or more memory storage devices of the one or more media control devices;
c) establishing of one or more second volume profiles respectively for one or more second audio components which includes executing the reference audio file such that the plurality of test tones and the plurality of patterns associated with the reference audio file are emitted from the one or more second audio components and detected by the one or more microphones and/or the one or more sound pressure level meters and converted into electrical signals then converted into second volume data, the second volume data is associated with a plurality of volumes of the one or more second audio components by the one or more processors of the one or more media control devices and transferred for storage in the one or more second volume profiles in the one or more memory storage devices of the one or more media control devices;
d) performing a first mapping step of the first volume profile relative to the reference volume profile, wherein the first volume data comprising the full volume range of the first audio component is correlated to a reference volume data of the reference volume profile using value-based mapping;
e) performing one or more second mapping steps of the one or more second volume profiles relative to the reference volume profile, wherein the second volume data comprising the full volume range of the one or more second audio components is correlated to the reference volume data of the one or more second volume profiles by the one or more processors and using value-based mapping;
f) calculating a normalization profile over a range of sound pressure levels based upon the first mapping step and the one or more second mapping steps, wherein one or more logarithmic scales associated with the first volume data in the first volume profile and the one or more second volume data in the one or more second volume profiles are converted into one or more linear scales;
g) automatically adjusting a volume of the first audio component, the one or more second audio components, or both so the volume of the first audio component matches the volume of the one or more second audio components; and
h) automatically confirming an outputted volume of the first audio component, the one or more second audio components, or both substantially equals or differs from the desired volume and repeating the automatically adjusting the volume if the outputted volume does not substantially equal the desired volume.

19. The method of claim 18, wherein the first mapping step, the second mapping step, the calculating, or combination thereof are executed by the one or more processors of the one or more media control devices, one or more other processors external to the one or more media control devices, or any combination thereof.

20. A media control device configured for adjusting a volume of one or more audio components, the media control device comprising:
a) one or more storage mediums having stored therein:
i) one or more volume profiles associated with one or more audio components;
ii) a reference volume profile;
iii) a normalization method for calculating a normalization profile over a range of sound pressure levels based on the one or more volume profiles;
b) one or more processors configured to access and execute the normalization method and adjust an output volume of one or more audio components; and
c) one or more communications means for two-way communication with and configured to be in electrical signaling communication with the one or more audio components; and
optionally, wherein the method of claim 1 is stored within the one or more storage mediums and accessible by the one or more processors.
